(19) United States
(12) Patent Application Publication
(10) Pub. No.: US 2011/0253444 A1
(43) Pub. Date: Oct. 20, 2011

(54) POLARITY CONTROL OF ELECTROMOTIVE FORCES

(76) Inventors: Kitaru Watanabe, San Jose, CA (US); Tsuyoshi Asano, Santa Clara, CA (US); Jun Morinaga, Kmimashiki-Gun (JP); Satoshi Terao, Kikuchi-Gun (JP)

(21) Appl. No.: 12/762,785

(22) Filed: Apr. 19, 2010

(51) Int. Cl. H01R 4/00; H01R 43/00

(52) U.S. Cl. 174/84 R; 29/825

(57) ABSTRACT

Example embodiments of the present invention provide the ability to control or set the electromotive force (emf) potential observed in an electronic component by adjusting the resistivity at conducting junctions within it. More specifically, at joints where emf potentials exist due to conducting materials of different types (e.g., two different metals), the resistivity of these conducting junctions is varied, which sets the overall polarity of the emf observed across the component itself. In other words, varying the resistivity at conducting junctions relative to one another, example embodiments control the polarity of the emf within the component itself. As such, the components may then be connected in series or other manner to reduce the overall emf potential induced into a system.

### CROSS-REFERENCE TO RELATED APPLICATIONS

N/A

### BACKGROUND

Electronic components form the basic building blocks for making electronic device with a particular function (e.g., radio receiver, cellular phone, computing device, etc.). More specifically, each device comprises electronic circuit(s) designed to perform specific tasks thru the flow electricity along a conducting path or paths formed by interconnecting the electronic components together. Prior to integration into the circuit, components are packaged singly (e.g., resistor, capacitor, transistor, diode, etc.) or in more or less complex groups as integrated circuits (operational amplifier, resistor array, logic gate, etc.). Such packaging often encloses the one or more electronic components in a synthetic resign—which mechanically stabilizes them, improves insulation properties, and protects them from environmental influence. Two or more connecting leads or metallic pads extend from the packaging, which allows the various components to join together—usually by soldiering them to a printed circuit board (PCB)—completing the circuit design.

Fundamentally, each electronic component behaves according to a lumped element model, which assumes each basic element has ideal properties that operate as a finite point in space with perfect conducting leads. In reality, however, electronic components exhibit some form of deviation from their ideal lumped element—i.e., their values always have a degree of uncertainty, they always include some degree of nonlinearity, and typically require a combination of multiple electrical elements to approximate their functions. Such deviation from ideal behavior comes from several sources including: the components exposure to environmental changes in heat, pressure, precipitation, etc.; and/or due to the operational physics (e.g., the induced current, heat, magnetism, structural limitations, etc.) not accounted for in the simplistic lumped element model.

Of course, the design and manufacturing process of the components play a significant role in determining the extent of deviation induced. In fact, even the mere choice of materials used for an electronic component can influence the deviations from the ideal behavior. Take for example a temperature change across a single conducting solid (e.g., a semiconductor material) of an electronic component. Such temperature gradient induces a thermoelectric voltage across the material, the magnitude of which is often termed the thermopower or Seebeck coefficient of the material (commonly measured in microvolts per Kelvin (μV/K)). The flow of current due to the thermopower is often expressed in terms of electromotive force (emf), which describes the external work per unit charge expended to produce an increase electrical potential. The emf of a material is a non-linear function that depends on a conductor's absolute temperature and crystal or molecular structure and any current induced thereby can naturally affect a component's normal behavior.

In other words, the magnitude of the induced voltage will vary based simply on the type of material used in manufacturing the component. Of course, how and to what extent these emf voltages alter a component's behavior will vary widely based on a number of other factors as well. Nevertheless, the point remains that even the simple choice of an electronic component's material makeup causes deviations in the anticipated lumped electrical model.

Besides thermopower, the varying types of materials used in manufacturing a component can introduce other sources of emf. For instance, a natural phenomenon known as contact potential occurs when two different types of solids come in contact with one another. In general, at the conducting junction of differing conducting materials (i.e., metals and semiconductors), thermodynamic equilibrium requires one of the solids to assume a higher electrical potential than the other. More specifically, upon contact, electrons will flow from the material with a lower work function to the material with the higher work function—where the work function basically describes the minimum energy needed to excite or liberate an electron from the surface or Fermi level of a particular material with a conduction band (whether empty or partly filled). Due to the energy advantage in taking an electron from one conducting body to the other, this transfer causes a charge separation or potential difference between them.

Over time, the charge transfer becomes increasingly difficult due to the charge separation. When the electrochemical potential of the electrons in the bulk of both phases are equal, the transfer of electrons stops and the potential difference has the value called the contact potential. In other words, when the gain in energy due to the transfer of electrons matches the work necessary to remove an electron from the lower work function material to the higher one, thermodynamic equilibrium occurs. At this point, the induced energy transfer creates an emf across the conducting junction—the magnitude of which is often expressed as a difference in Fermi levels of the two solids—again, typically expressed in μV/K. (The Fermi level—a name for the chemical potential of an electron system—describes the energy necessary to remove an electron from a solid's surface.) Note, however, the contact potential cannot necessarily drive current through a load attached to its terminals because that current would involve a charge transfer. No mechanism exists to continue such transfer; and hence, maintain a current once equilibrium is attained.

In the case where a temperature difference provides some external work beyond the electrochemical potential, the emf potential is proportional to the temperature difference between the two solids. Unlike the emf created from contact potential, however, in the presence of a closed loop circuit, the emf potential can result in the flow of electrical current. Similar to the temperature gradient across a single conducting material, such conversion of temperature difference directly into electricity is also called the “Seebeck” effect, which in this case quantifies the thermoelectric emf between two different metals or semiconductors along with the flow of current if the conductors form a complete loop. As noted above, however, the flow of current due to thermoelectricity occurs not only between differing conducting materials, but also within the materials themselves. Further, if two connections are held at the same temperature, but one connection is periodically opened and closed, an AC voltage is observed that is also temperature dependent.

Of course, there are other factors and sources that induce emf in electronic components besides thermoelectricity and electrochemical effects. For example, the above described region of the thermopower-versus-temperature-versus-electrochemical function is highly variable under a magnetic field (or flux), which naturally occurs in many electronic components and circuits (e.g., an electrical relay, inductor, etc.). Further, the motion of circuit leads or other conducting materials in magnetic fields also generates spurious voltages. Even the earth's relatively weak magnetic field can generate nanovolt noise levels in dangling leads, pads, and related conducting materials. Basic physics shows that the amount of voltage a magnetic field induces in a circuit is proportional to the area of the conduction material acted thereon. Nevertheless, there exists unpredictability for magnetically induced emf potentials in circuits that use AC current. In other words, in circuits that use AC current, the emf induction into components may be enhanced or lessoned at various intervals of the alternating current by changing magnetic induction effects in that system.

In sum, a source of emf can be thought of as a kind of charge pump that acts to move positive charge from a point of low potential through its interior to a point of high potential. By chemical, thermal, electrical, mechanical, or other means, the source of emf performs work on that charge to move it to the high potential terminal. The unpredictability of the sources of emf contributes to an electronic component's actual behavior in the real world. Likewise, the additive nature of these potential differences creates a risk of larger current flows from a series of components that potentially damage highly sensitive circuits or cause other unwanted results. Accordingly, device manufacturing, quality assurance, and research groups often make resistance measurements (force current/measure voltage) to monitor, evaluate, and study the quality of their devices and materials under such conditions. These device manufacturers could be relay, connector, MR head suppliers, or any other number of component distributors that need to ensure their products work according to spec in fulfilling their customer's needs. As electronics continue to shrink to meet consumers' demand for faster, more feature-rich products in ever-smaller form factors, emf noise creates several other inherent problems.

For example, testing these components and devices often includes making low-voltage measurements; but alas, the above described emf potentials and many other factors make low voltage measurements difficult. Nevertheless, techniques for making precision, accurate voltage measurements are fairly well known. A lot of these methods, however, fall short when resolution must be extended below one microvolt, which is often the case when measuring physical parameters in industry such as temperature, pressure, force, etc. For instance, and for related reasons previously mentioned, various noise sources can hinder resolving the actual voltage, and emfs can cause error offsets and drift in voltage readings. In the past, testers simply increased the test current until the device under test's (DUT's) response voltage was much larger than these errors, but with today's smaller devices this is no longer an option. Increased test current can cause device heating, changing the device's resistance, or even destroy the device. As such, the key to obtaining accurate, consistent measurements is eliminating the error.

### BRIEF SUMMARY

The above-identified deficiencies and drawback of current electronic components under low voltage testing are overcome through example embodiments of the present invention. For example, embodiments described herein provide for an electromotive force (emf) polarity controlling mechanism for components such that a series of components can be linked together to minimize the effects of the emf in low-voltage testing. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example embodiment provides for components and processes that control the emf polarity of an electronic component by adjusting or controlling its resistivity at various conducting junctions formed therein. As defined herein, a conducting junction joins two conducting materials together for allowing current to flow in an electrical circuit. Under low-voltage testing conditions, the electronic component gains an electromotive force (emf), which tends to cause current (actual electrons and ions) to flow, across the component. Such emf exists due to conditions or phenomena such as electrochemical effects, thermoelectricity, electromagnetic induction, and others. In order to minimize these effects during low-voltage and other testing procedures, example embodiments control or predefine the polarity across the component, such that components can then be collectively connected in a series of opposing charges in order to reduce the overall emf in a circuit.

More specifically, example embodiments provide for an electronic component with a first conducting junction formed by connecting a first set of conducting materials together using a first connection type. The first connection type is chosen on the basis of controlling emf polarity inherent in the electronic component. The electronic component also comprises a second conducting junction formed by connecting a second set of conducting materials together using a second connection type different from the first connection type. Similar to the first, the second connection type is chosen on the basis of controlling the emf polarity inherent in the electronic component.

In other words, by adjusting and controlling the resistivity at these conducting junctions relative to each other, example embodiments predefine the polarity of any emf induced into a component from the above external and inherent sources. Although the magnitude of the emf induced into such components may still exist and vary from component-to-component, current described embodiments allow for the substantial reduction of emf in testing and other circuit configurations by connecting the components in series with alternating polarity configuration. More specifically, by connecting a positive emf potential lead of one component to the positive lead of another, the overall net emf potential between the two components equals something less than each individual emf induced.

Other example embodiments provide a manufacturing process, which induces a specific emf polarity in an electronic component by first determining a desired emf polarity for an electronic component. Based on the desired emf polarity of the electronic component, a first connection type is selected for joining a first set of conducting materials. Then, a first conducting junction is formed by joining the first set of conducting materials together using the selected first connection type. Also based on the desired emf polarity of the electronic component, a second connection type is selected, which differs from the first connection type. And, the second connection type is then used for joining a second set of conducting materials. Then a second conducting junction is formed by joining the second set of conducting materials together using the second connection type. Thereafter, the first and second conducting junctions are packaged in discrete form as the electronic component with extending leads used in completing an electrical path in a circuit.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1a illustrates a graphical sample of emf measurement data for a set of typical reed-relay switches, which shows random polarity and magnitude distribution of EMF potentials in prior art components;

FIG. 1b illustrates a graphical sample of emf measurement data for a set of reed-relay switches with Laser-Sn/Pb soldier polarity control in accordance with example embodiments of the present invention;

FIG. 2a illustrates a schematic diagram of a reed-relay component and the configuration of a low voltage multi-meter for collecting emf measurement data in accordance with example embodiments; and

FIG. 2b illustrates the top-side views of a reed-relay switch and the conducting junctions used to adjust the resistivity and control emf polarity in such components according to example embodiments described herein.

### DETAILED DESCRIPTION

The present invention extends to methods, systems, and devises for minimizing the effects of electromotive forces (emf) in a component. More specifically, by adjusting the resistivity of conducting junctions, example embodiments preset or control the polarity of induced emf potentials across these junctions; and thus, control the polarity of emf across the electronic components themselves. In turn, by utilizing the additive nature of series voltages, a set of controlled polarity components can be connected in series with alternating polarity; thus, reducing the overall emf potential observed in the electronic circuit or for a set of components under test.

As previously mentioned, thermoelectric and electrochemical emfs are the most common source of errors in low voltage measurements. A source of emf can be thought of as a kind of charge pump that acts to move positive charge from a point of low potential through its interior to a point of high potential. By chemical, mechanical or other means, the source of emf performs work dW on that charge to move it to the high potential terminal. The emf ε of the source is defined as the work dW done per charge dq: ε=dW/dq, which is typically expressed in μV/K or sometimes simply μN.

As known in the art of electronic testing, significant errors may be introduced by various noise sources including: (i) DC offset voltages from thermoelectric, electrochemical, or magnetic fields; (ii) random and unpredictable “white noise” (with a Gaussian distribution) or the component under test, along with test equipment, Johnson noise; and/or (iii) thermoelectric effects due to variable heating of a device. Of course, for most components and circuits, this relatively small induced thermoelectricity has little if any barring on the ideal behaviors of components or on the system itself. In other words, for high resistance circuit components, the few micro volts (μV) induced by a temperature gradient or other means rarely affects the testing of the component. On the other hand, for highly sensitive, low power electronics, even a few μV can introduce unwanted offset voltages and noise that cause measurement errors and other undesired results. In addition, these smaller electronic components usually have limited power handling capability; and as a result (when electrically characterizing these components), the test signals need to be kept small to prevent component breakdown or other damage. Taking steps to understand and minimize these factors is crucial for meaningful measurements at low voltages.

As a reminder, these voltages arise from various electrical, chemical, thromo, and mechanical sources such as when different parts of a circuit are at different temperatures or when conductors made of dissimilar materials are joined together, as in an ordinary solder joint. As an example, the thermoelectric emf of tin/lead (Sn/Pb) solder with respect to copper is approximately 3 μV/° C. Although constructing circuits using the same material for conductors minimizes the thermoelectric emf, such construction is impractical and cannot necessarily eliminate all forms of induced emf.

Nevertheless, steps can be taken to minimize thermoelectric emfs. For example, connections made by crimping copper sleeves and lugs result in coldwelded copper-to-copper junctions that can generate minimal thermoelectric emf potentials. Minimizing temperature gradients within the circuit also reduces thermoelectric emfs. A typical practice is to place all junctions in close proximity and provide good thermal coupling to a common massive heat sink or electrical insulator having high thermal conductivity. Since most electrical insulators do not conduct heat well, special insulators such as hard anodized aluminum, beryllium oxide, specially filled epoxy resins, sapphire, or diamond often must be used to couple junctions to the heat sink.

For example, in circuits with larger components, the thermoelectricity may be insulated with alumina type materials formed on a component's lead or in-between the circuit components. As the size of components decreases, however, such use of ceramic type alumina becomes difficult and impracticable. More specifically, the high temperature and pressure used to package the smaller components often breaks the brittle alumina insulation structure. Further, attaching thermal couplers between components for testing purposes becomes cumbersome and unwieldy when testing hundreds or thousands of small components or devices each day.

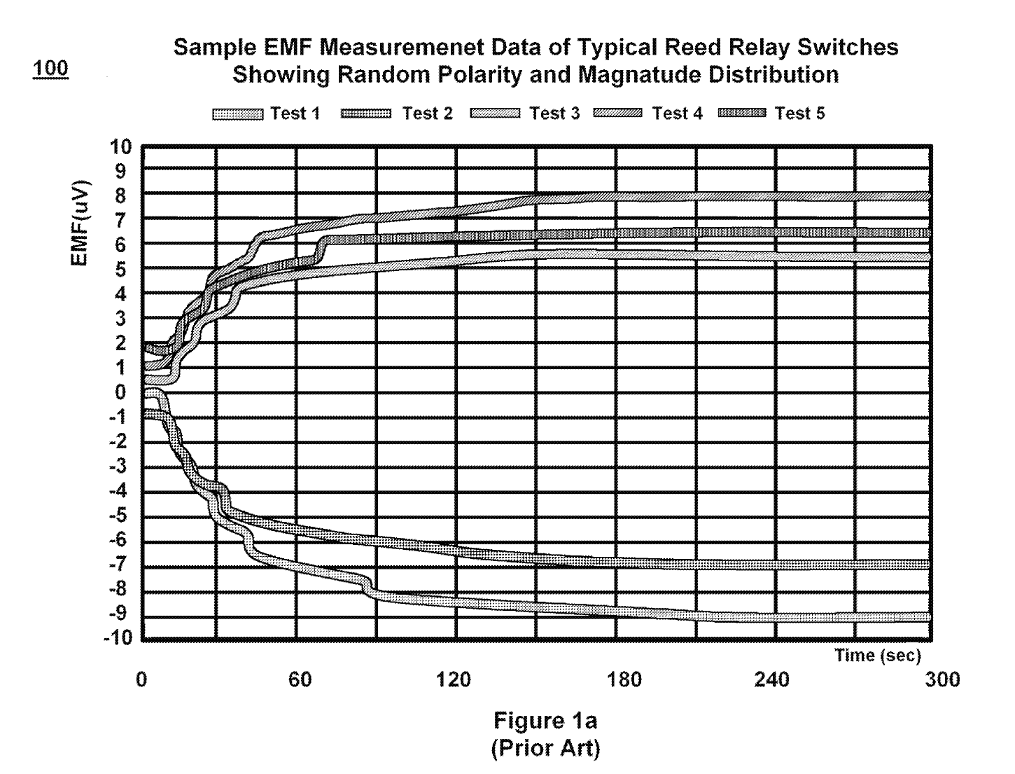

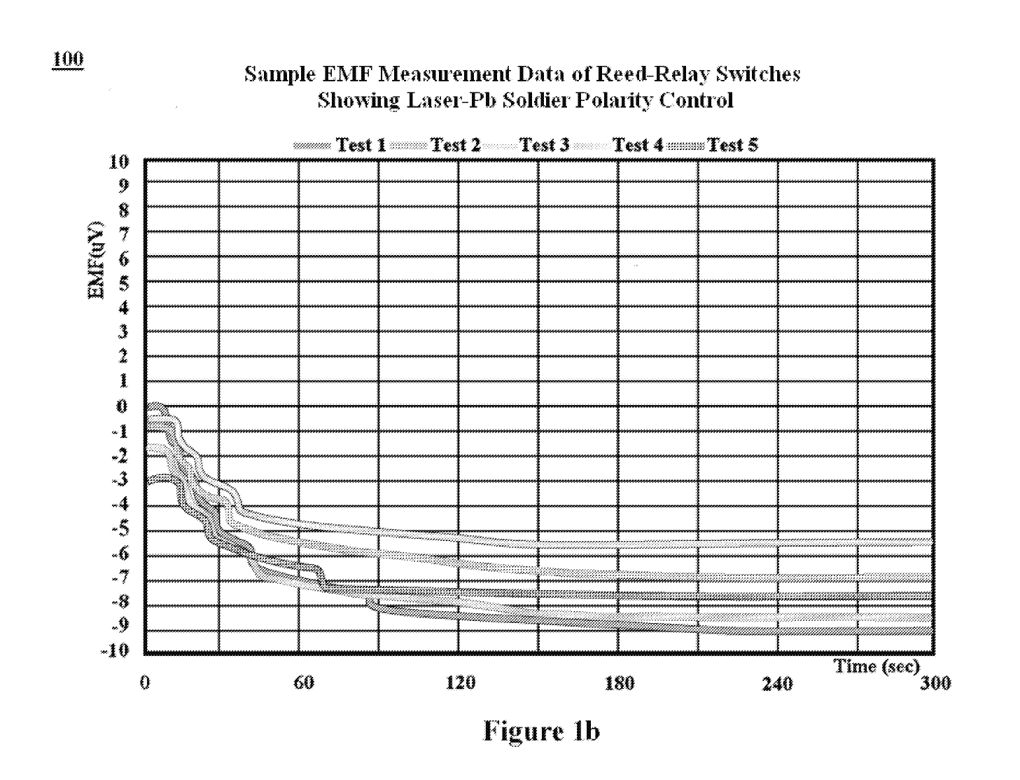

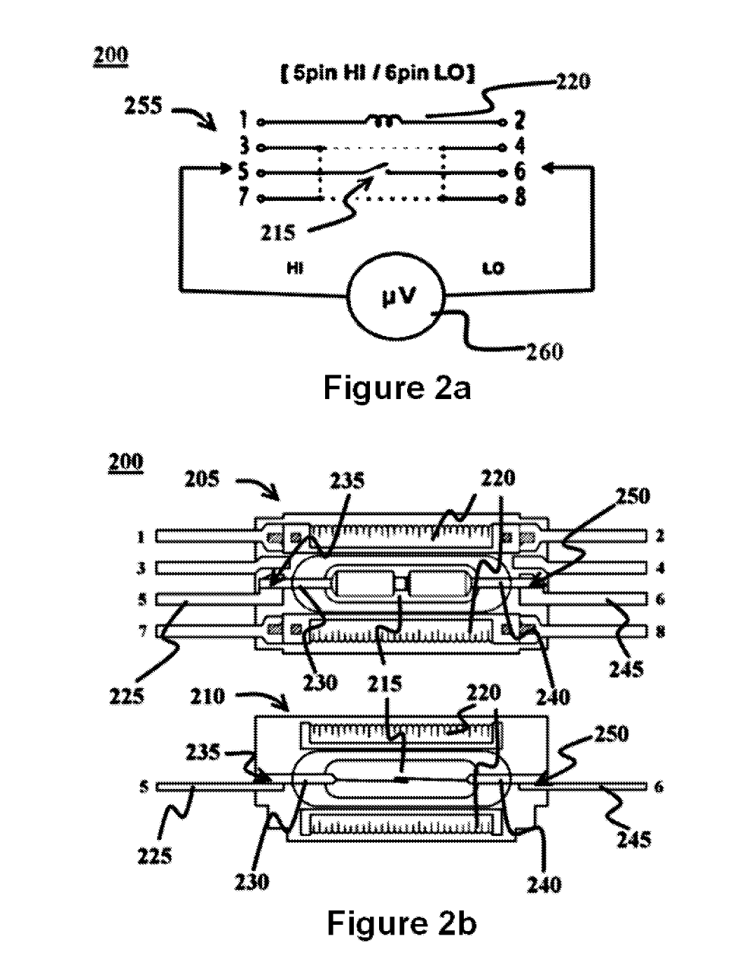

As an example of the unpredictable nature of emf voltages in a component, FIG. 1a illustrates a sampling emf measurement data for five randomly selected reed-relay switches. More specifically, FIG. 2a shows an example schematic pin configuration 255 of a typical reed-relay switch 200, wherein pin 5 was tied to the “HI” or positive side of the low-voltage multi-meter 260 and pin 6 was connected to the “LO” or common probe. When switch 215 was closed (using NO relays) by activating coils 220, emf measurements were taken as a function of time as shown in chart or graph 100.

Note that in this experiment, the conducting junctions 235, 250 for the reed relays under test (as shown in the cutaway view in FIG. 2b of a typical reed relay 200 for pins 5 and 6, respectively), were formed of a typical Sn/Pb solder connection type. Nevertheless, other types of connection types (e.g., laser) will produce similar results. Also note that these and other similar measurements require the use of a clean room and other very will maintained and monitored environmental conditions (e.g., controlled temperatures around 25+2 degrees Celsius with a 40% relative humidity factor and specialize shied box).

As seen from FIG. 1a, each of the five sample reed relay's (tested as data for Test 1 thru Test 5) emf potential varied from the others in terms of both magnitude and polarity. In other words, despite the fact that each reed relay switch was connected the exact same way as FIG. 2a, the resulting data indicates that an emf potential across even some relatively simple components will vary widely. In fact, out of the five samples of data taken, not a single emf potential difference was equal in magnitude and the distribution of emf polarity was almost split equal.

Note that although the measurement data and example embodiments described herein are applied and described in terms of reed relay switches, the current invention equally applies to other electronic components. In fact, as will be evident shortly, any electronic component with two or more conducting junctions or joints can utilize embodiments described herein for controlling junction resistivity and emf polarity of these junctions (and thus across the electronic component). As such, the use of reed relay switches or any other type of electronic component in describing embodiments of the present invention, are used herein for exemplary purposes only and are not meant to limit or otherwise narrow the scope of the present invention unless otherwise explicitly recited in the claims.

As briefly mentioned above, FIG. 2b illustrates a top 205 and side 210 cut-away views of a typical reed relay switch 200, which shows hermetically sealed contacts 215 on ferromagnetic leads (e.g., iron, cobalt, or nickel) plated with a precious metal such as rhodium, iridium, durel or ruthenium, with an under layer of gold, copper, tin, tungsten or other similar metal. A coil of fine wire 220 wound on a bobbin surrounds a glass capsule containing the switch contacts 215. Electrical current through the wire 220 acts as an inductor that creates a magnetic field for moving the contacts 215. In a normally open (NO) configuration, the contacts 215 in the presents of the magnetic field are moved together for conducting electricity or completing an electrical path, whereas in a normally closed (NC) switch the contacts 215 move apart for interrupting a circuit. The precious metal contacts 215 are suspended in the glass tube by supporting members 230 and 240 on the left and right hand sides of the reed relay, respectively. Typically, the supporting members 230 and 240 are then attached to leads 225 and 245 for connecting the device 200 to a printed circuit board (PCB) or other connection source.

Note that the supporting members 230, 240 come in contact with leads 225, 245 to form connecting junctions or joints 235 and 250, respectively. Typically, the supporting members 230, 240 are made of conducting materials that differ from those of the leads 225, 245. As such, when the differing metals or conducting materials are connected or joined, emf potentials are created by the electrochemical properties of the materials as previously described. These emf potentials may further be enhanced by the electromagnetic field of the coiled wire 220, the temperature gradient induced in the reed relay 200 when in normal operation, and other previously described external and internal sources.

In accordance with example embodiments, the polarity of the emf observed across the reed relay 200 is controlled by adjusting the resistivity at the conducting junctions 235 and 250. Note that the adjustment of the resistivity at these points 235, 250 can occur by any well known mechanism for joining or adhering the junction or joint together. For example, the resistivity can be established or adjusted by any well known connection type such as soldering, cold connecting, welding, gluing, riveting, fusing, brazing, welding, and adhering. Of course, other well known connection types that vary in resistivity can be used for implementation of example embodiments. In fact, it is noted that the same type of connection mechanisms may vary in resistivity. For example, it is known in the art that a solder joint of varying sizes will have different resistivity based on the amount of solder alloy used. Similarly, as described below, the types of conducting materials used in conjunction with the type of connection type can form the basis for adjustment of the resistivity value. Of course other well known mechanisms for adjusting the resistivity of a connection types are also contemplated herein. Therefore, the terms “different connection type” or other similar phrase used herein is meant to connote that they differ in resistivity values or adjustment and not necessarily a particular type of connection—although the use of different types of connections may be a more practical mechanism for controlling polarity. Similarly, any specific use of a particular type of connecting mechanism used herein is for illustrative purposes only and is not meant to limit or otherwise narrow the scope of the present invention unless otherwise explicitly recited in the claims.

Regardless of the type of resistivity adjustor used, the connection types for each of the conducting junctions 235, 250 will be based on the type of polarity desired or needed. More specifically, in order to control the polarity of the emf potential across the device 200, a connection type of one form is used for connecting the support member 230 to the lead 225 at conducting junction 235, while a different connection type is used for connecting the support member 240 to the lead 245 at the other conducting junction 250. In other words, the polarity control mechanism used is the adjustment of the resistivity at the conducting junctions 235, 250 by using differing connection mechanisms at these points 235, 250. By controlling or adjusting the resistivity at the conducting junctions 235, 250 such that these two points 235, 250 inherent different resistivity characteristics, the overall emf across the device 200 is also predetermined or controlled.

Note also that typically the materials used for the leads 225, 245 are the same type of conducting materials (e.g., copper). Similarly, the supporting members 230, 240 will typically be made of the same conducting material (e.g., iron sputtered with rhodium); however, as noted previously the supporting members' 230. 240 materials will differ from that of the leads' 225, 245. Nevertheless, as previously noted above, it is also contemplated herein that the varying of resistivity at the conducting junctions, and thus controlling of emf polarity, may still be accomplished if the leads 225, 245 and/or supporting members 230, 240 are themselves of differing materials. In other words, conducting junction 235 can be formed by a first set of conducting materials, while conducting junction 250 is formed by a different set. Further, the type of resistivity adjustor or connection type used to join conducting junctions may be different or the same. All that is necessary for varying the resistivity is that one of the junctions forms a resistivity conducting junction at 235 that differs from that of 250 and that the values of each are predetermined or known. More specifically, as will be shown hereinafter, the resistivity at one conducting junction (e.g. 235) needs to be at a higher resistivity than the other conducting junction (e.g., 250), forming a negative polarity relative to the higher resistivity junction.

For example, FIG. 2b illustrates a graphical plot 100 of sample measurement data for five reed relay switches for emf potentials across the switches as a function of time in seconds. With a laser weld for the conducting junction 235 (or pin 5) and a Sn/Pb solder weld at the other conducting junction 250 (corresponding to pin 6 in FIGS. 2a and 2b)—and with the low-voltage multi-meter 260 connected as previously noted in FIG. 2a—a negative polarity exits for each emf potential across the five reed relay test samples (Test 1 thru Test 5). In other words, by using a laser weld on the conducting junction 235 with a higher resistivity value than the Sn/Pb solder used on the other conducting junction 250, example embodiments control or predetermine the polarity across each reed relay 200 to have a negative value when the 5 pin of the switch is set to “HI” and the 6 pin is connected to the “LO” probe of the low-voltage meter 260. Of course, any other type of combination of resistivity connects can be used to create the difference in resistivity values observed at the different conducting junctions across an electrical components; and therefore, the specific use of the laser-Pb solder polarity control mechanism is used herein for illustrative purposes only and is not meant to limit or otherwise narrow the scope of the invention unless otherwise explicitly claimed.

In other words, a higher resistivity value across a first conducting junction relative to a lower resistivity value formed a second conducting junction creates a negative emf potential. Thus, the use of resistivity adjustors or connection types for forming such a configuration will allow for the predetermination of the polarity across a given component. Accordingly, as previously mentioned, the resistivity adjustment mechanism for controlling emf potentials across a component, or even across multiple components, can be controlled using the resistivity adjustment mechanism described herein.

Regardless of the types of resistivity adjustors used, note that the magnitude of the emf potentials across the reed relays 200 (and other electronic components) remains randomly distributed. Nevertheless, such magnitudes may be somewhat reduced using the above described mechanisms or other well known ways of reducing emf values. By controlling the polarity measurements in accordance with the embodiments of the present invention, however, one can now even further reduce the over all effects of the emf potentials in a system. More specifically, since embodiments now set the polarity of each individual component, the configuration of these components can utilize the mathematical properties (e.g., the additive nature in series configuration) of voltage potentials such that the overall emf observed in the circuit is reduced.

For example, the components can be arranged in series fashion with alternating polarities. Thus, the positive magnitude of one emf will be reduced by the negative configuration of the next component in the series. In other words, by connecting a positive side of one polarity controlled component to the positive side of another, the resulting emf across the two components will be the difference between them. Although the magnitude of each emf observed in the various components will differ; and thus, the overall reduction in emf potential will likely not equal zero, the law of averages allows embodiments to net a close approximation to zero emf potentials. Note also that the components may also be connected in parallel or some combination of series and parallel; however, the net reduction will not be as significant as summing the emf values using alternating polarities in series.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. An electronic component comprising:
a first conducting junction formed by connecting a first set of conducting materials together using a first connection type chosen on the basis of controlling a electromotive force (emf) polarity inherent in the electronic component; and
a second conducting junction formed by connecting a second set of conducting materials together using a second connection type different from the first connection type and also chosen on the basis of controlling the emf polarity inherent in the electronic component.

2. The electronic component of claim 1, wherein the first set of conducting materials differ and second set of conducting materials differ, and wherein the first and second sets of conducting materials comprise an identical set of conducting materials.

3. The electronic component of claim 2, wherein at least one of the conducting materials in the identical set of conducting materials includes a lead material for the electronic component used in connecting it to a printed circuit board.

4. The electronic component of claim 3, wherein another of the conducting materials in the identical set of conducting materials includes a metal used to connect a first and second lead together such that the first conducting junction connects a first piece of the metal to the first lead and the second conducting junction connects a second piece of the metal to the second lead.

5. The electronic component of claim 4, wherein the first and second pieces of the metal connect together via a switch in between them in order to pass current from the first lead to the second lead when the switch is in a closed position, and wherein the emf is observed between the first and second leads.

6. The electronic component of claim 5, wherein the electronic component is a reed relay switch.

7. The electronic component of claim 1, wherein the first and second connection type are chosen from the list comprising: soldering, cold connecting, welding, gluing, riveting, fusing, brazing, welding, and adhering.

8. The electronic component of claim 1, wherein the electronic component is arranged in a circuit with other polarity controlled electronic components in an opposite polarity fashion for reducing the overall unwanted noise in the circuit.

9. In an manufacturing process, a method of controlling electromotive force (emf) polarity when fabricating an electronic component, the method comprising:
determining a desired emf polarity for an electronic component;
based on the desired emf polarity of the electronic component, selecting a first connection type for joining a first set of conducting materials;
forming a first conducting junction by joining the first set of conducting materials together using the selected first connection type;
based on the desired emf polarity of the electronic component, selecting a second connection type, different from the first connection type, for joining a second set of conducting materials;
forming a second conducting junction by joining the second set of conducting materials together using the second connection type; and
packaging the first and second conducting junctions in discrete form as the electronic component with at least two leads used in completing an electrical path in an electrical circuit.

10. The method of claim 9, wherein the first set of conducting materials differ and second set of conducting materials differ, and wherein the first and second sets of conducting materials comprise an identical set of conducting materials, and wherein at least one of the identical set up conducting materials in a metal used to form the leads for connecting the electronic components to a printed circuit board.

11. The method of claim 9, wherein the first and second connection types are selected from the list comprising: solder, cold connection, weld, glue, rivet, fuser, or adhesion mechanism.

12. The method claim 11, wherein the connection type is a solder and the second connection type is a laser weld.

13. The method of claim 9, wherein the first and second set of conducting materials are various types of conducting metals.

14. The method of claim 9, wherein the first and second set of conducting materials include the leads for connecting the electronic component to a printed circuit board (PCB).

15. The method of claim 14, wherein the leads for connecting the electronic component to the PCB are temporary or removable connection mechanisms.

16. A manufacturing process for controlling electromotive force (emf) polarity when fabricating an electronic component, the process comprising:
a first connection means for joining a first set of differing conducting materials based on a desired emf polarity for an electronic component, wherein the joining of the first set of differing conducting materials forms a first conducting junction for completing an electrical path;
a second connection means, different from the first connection means, for joining a second set of differing conducting materials based on the desired emf polarity for the electronic component, wherein the joining of the second set of differing conducting materials forms a second conducting junction for completing an electrical path; and
a packaging mechanism that forms the first and second conducting junctions in discrete form as the electronic component with at least two leads used in completing an electrical path in an electrical circuit.

17. The method of claim 16, wherein the first and second connection types are selected from the list comprising: solder, cold connection, weld, glue, rivet, fuser, or adhesion mechanism.

18. The method of claim 16, wherein the first and second set of conducting materials include semi-conductor materials.

19. The method of claim 16, wherein the first and second set of conducting materials include the leads for connecting the electronic component to a printed circuit board (PCB).

20. The method of claim 19, wherein the leads for connecting the electronic component to the PCB are temporary or removable connection mechanisms.
